(19) United States
(12) Patent Application Publication
(10) Pub. No.: US 2015/0247601 A1
(43) Pub. Date: Sep. 3, 2015

(54) METHOD AND SYSTEM FOR HEATING NATURAL GAS

(71) Applicant: BASF SE, Ludwigshafen (DE)

(72) Inventor: Mirko Haider, Maxdorf (DE)

(73) Assignee: BASF SE, Ludwigshafen (DE)

(21) Appl. No.: 14/427,126

(22) PCT Filed: Sep. 17, 2013
(86) PCT No.: PCT/EP2013/069201

§ 371 Date: Mar. 10, 2015

(30) Foreign Application Priority Data
Sep. 18, 2012 (EP) 12184841.0

(51) Int. Cl. F16L 53/00; F28D 9/00; F17D 1/05

(52) U.S. Cl. CPC F16L 53/002; F17D 1/05; F28D 9/00

(57) ABSTRACT

The invention relates to a method and a system for heating natural gas, comprising the following method steps: a) supplying natural gas, which has a temperature in the range between −10 DEG C and 50 DEG C and a pressure of at least 30 bar, from a natural gas supply line to a first hollow chamber system of a heat exchanger, b) supplying a heating medium, which has a temperature in the range between 30 DEG C and 60 DEG C, to a second hollow chamber system of the heat exchanger, the first and the second hollow chamber systems being sealed from each other and relative to the surroundings, c) heating the natural gas in the first hollow chamber system to a temperature in the range between 20 DEG C and 150 DEG C by means of the heating medium in the second hollow chamber system, a plate heat exchanger being used as the heat exchanger and comprising at least two pairs of heat exchanging plates, at least the outer edges of the heat exchanging plates of each pair of heat exchanging plates being completely welded together, and d) leading away the heated natural gas from the first hollow chamber system to at least one further treatment step.

The present invention relates to a method and a plant for the heating of natural gas.

Natural gas is transported, as a rule with a pressure of more than 40 bar, from conveying and processing plants via supply lines (long-distance lines) to gas suppliers and other major customers, such as in the chemical industry. The natural gas has in this case a temperature of between 0° C. and 25° C., depending on pressure, supply length and outside temperature.

Both where gas suppliers and the chemical industry are concerned, the pressurized natural gas has to be intermediately expanded to a lower pressure so that it can be employed for various intended uses. Since, during expansion, a gas cools on account of the Joule-Thomson effect, it has to be heated before and/or after expansion in order to restore the initial temperature and thus prevent undesirable secondary effects, such as, for example, condensation.

According to the prior art, the heating of a pressurized gas is carried out in heat exchangers, in which the gas is brought into contact directly or indirectly with a heating medium, the gas being heated and at the same time the heating medium being cooled. A heat exchanger type which is in widespread use is tube bundle heat exchangers in which the gas to be heated is routed through a bundle of heat exchanger tubes, around which a heating medium is washed. However, tube bundle heat exchangers have the disadvantage that they require a large amount of space.

By contrast, plate heat exchangers are more space-saving and have higher efficiency.

In order to utilize the advantages of a plate heat exchanger and increase the efficiency of an existing plant, WO 2009/152830 A1, for example, discloses a conversion kit for a tube bundle heat exchanger, in which the tube bundles are removed from a conventional cylindrical heat exchanger and are replaced by a stack of heat exchanger plates.

The problem of the plate heat exchangers known in the prior art is, in general, that they are not suitable for the heating of natural gas which is under a pressure of at least 30 bar or are not described for such use.

Against this background, the object of the invention is to provide a method and a plant so that pressurized natural gas can be heated reliably and efficiently.

This object is achieved, in the first aspect of the present invention, by means of a method for the heating of natural gas which comprises the method steps:

a) delivery of natural gas which has a temperature in the range of −10° C. to 50° C. and is under a pressure of at least 30 bar from a natural gas supply line to a first cavity system of a heat exchanger,

b) delivery of a heating medium which has a temperature in the range of 30° C. to 160° C. to a second cavity system of the heat exchanger, the first and the second cavity system being sealed off with respect to one another and with respect to the surroundings,

c) heating of the natural gas in the first cavity system to a temperature in the range of 20° C. to 150° C. by the heating medium in the second cavity system, and

d) discharge of the heated natural gas from the first cavity system to at least one further treatment stage.

In this case, the heat exchanger used is a plate heat exchanger comprising at least two pairs of heat exchanger plates, the heat exchanger plates of each pair of heat exchanger plates being welded together completely at least at their outer margins.

With regard to the plate heat exchangers according to the present invention, each pair of heat exchanger plates forms a cavity in which the medium to be heated (here, natural gas) or the heating medium flows. By two or more pairs of heat exchanger plates being connected, a cavity system is provided for one of the media. The pairs of heat exchanger plates are in this case arranged and connected to one another such that the medium to be heated and the heating medium flow alternately in each case through the successive cavities. The set-up composed of two or more pairs of heat exchanger plates is sealed off outwardly and between the two media. In this case, the individual plates may be suitably structured in order to allow optimal heat transfer.

In the method according to the invention, for the first time, a plate heat exchanger is used for heating natural gas. This use has, above all, the advantage of markedly higher efficiency, particularly due to higher heat transfer coefficients, as compared with the tube bundle heat exchangers conventionally used, and therefore, by having the same performance, is markedly more compact and lighter.

This has a positive effect upon space requirement and costs.

In a development of the method according to the invention, on account of the pairs of heat exchanger plates fully welded together, in method step a) the natural gas can be delivered to the heat exchanger with a pressure of up to 150 bar.

Preferably, the natural gas is process natural gas, this being understood in the context of the present invention to mean natural gas which is employed in a chemical reaction without any further material processing steps.

A method is preferred in which at least one further treatment stage is further heating and/or pressure reduction and/or chemical reaction and/or combustion.

The abovementioned object is achieved, in a second aspect of the invention, by means of a plant for the heating of natural gas, which comprises
a heat exchanger which has a first cavity system for natural gas and a second cavity system for a heating medium, the first and the second cavity system being sealed off with respect to one another and with respect to the surroundings,
a delivery for natural gas from a natural gas supply line to the first cavity system of the heat exchanger, and
a discharge for the heated natural gas from the first cavity system to at least one further treatment stage.

The plant is distinguished in that the heat exchanger is a plate heat exchanger comprising at least two pairs of heat exchanger plates, the heat exchanger plates of each pair of heat exchanger plates being welded together completely at least at their outer margins.

On account of the pairs of heat exchanger plates fully welded together, the plate heat exchanger can be acted upon directly with the pressurized natural gas, thus leading to higher efficiency. By virtue of the improved efficiency, moreover, the plate heat exchanger can have smaller dimensioning, as compared with a conventional tube bundle heat exchanger, this having a positive effect upon the costs of the plant according to the invention.

Preferably, by the pairs of heat exchanger plates being fully welded together, the plate heat exchanger can be acted upon with a pressure of up to 150 bar.

In a preferred embodiment of the plant according to the invention, the at least one further treatment stage has a further heat exchanger, in particular a plate heat exchanger, or an expansion device for the pressurized natural gas, with the result that an integrated plant for the heating and expansion of natural gas can be provided.

The plant according to the invention is suitable particularly for implementing the above-described method according to the invention.

The present invention relates, furthermore, to the use of a plate heat exchanger which comprises at least two pairs of heat exchanger plates, the heat exchanger plates of each pair of heat exchanger plates being welded together completely at least at their outer margins, for the heating of natural gas which is under a pressure of at least 30 bar. Such use has not been known hitherto from the prior art.

In this case, it is preferable that the plate heat exchanger is used for the heating of process natural gas, in particular with a pressure of up to 150 bar.

Further features, advantages and possibilities of use will be gathered from the following description of a preferred exemplary embodiment which, however, does not restrict the invention. In this case, all the features described form in themselves or in any desired combination the subject of the invention, also independently of the summary of these in the claims or their back reference.

Plants in which pressurized natural gas is used are subject in Germany to the directives of the DVGW (Deutscher Verein des Gas- and Wasserfaches e.V.) [German Association of the Gas and Water Trade R.A.] which lay down the technical boundary conditions, for example for gas transport. According to the DVGW directives, plate heat exchangers for the heating of pressurized natural gas are not permitted at the present time.

For large-scale plants in the chemical industry, which are not accessible to the public and for which the present invention is provided in particular, the directive 97/23/EG (“Druckgeräterichtlinie”) [“Pressure Apparatus Directive”] is therefore adopted, which lays down the requirements for bringing pressure apparatuses into circulation (that is to say, quality regulations). Furthermore, the operating regulations for the operators of pressure-carrying plants are implemented in the operational safety decree.

The essence of the plant according to the invention for the heating of natural gas, in particular process natural gas, is a plate heat exchanger, the individual pairs of heat exchanger plates of which are welded together completely along their outer margin, that is to say on their circumference. The outer regions of two heat exchanger plates in each case lie one on the other, and the outer margins are, in particular, bent up such that they form a V-shaped groove which is welded, preferably by means of a laser. For the connection of two pairs of heat exchanger plates, through-orifices are provided in the heat exchanger plates and are preferably welded together so that the cavity system obtained is closed so as to be pressure-tight. Two cavity systems which are sealed off with respect to one another and with respect to the surroundings form a plate heat exchanger, pairs of heat exchanger plates through which process natural gas flows and pairs of heat exchanger plates through which the heating medium flows being arranged alternately.

A plate heat exchanger such as is used, in particular, in the present invention is described, for example, in DE 10 2007 056 717 B3 and is obtainable from the company GESMEX GmbH, for example under the type designation XPS®. This is a kind of hybrid, since this type has the conventional geometry of a tube bundle heat exchanger, that is to say a cylindrical casing, but is equipped with stacks of heat exchanger plates.

The process natural gas, which is under a pressure of at least 30 bar (pressures of up to 150 bar are possible according to the invention) and which has a temperature of between −10° C. and 50° C., is delivered from a natural gas supply line directly to a first cavity system. At the same time, a heating medium with a temperature of between 30° C. and 160° C., preferably circulating via a closed line system and a heating device, is delivered to a second cavity system. The heating medium transmits its heat to the process natural gas via the thermally highly conductive material of the heat exchanger plates (for example, austenitic steel or Ni-based alloys).

The flows of process natural gas and heating medium may be routed codirectionally, in opposition or crosswise, structurings in the cavity systems causing swirling of the media, so that heat transfer is improved.

The heated process natural gas is discharged from the first cavity system to at least one further treatment stage which is heating and/or pressure reduction and/or chemical reaction and/or combustion.

Thus, for example, process natural gas can first be heated in the plant according to the invention, expanded in an expansion device, heated anew in a further plant according to the invention and subsequently delivered to a chemical synthesis plant, for example a plant for acetylene production.

The invention is described here with regard to the heating of process natural gas. It is basically suitable, however, for heating any other gaseous medium, in particular for the heating of heating natural gas.

The present invention provides for the first time a method and a plant for the heating of pressurized natural gas which are distinguished in that, as compared with the prior art, they have improved efficiency and enable the heat exchanger to have smaller dimensioning, with the result that marked cost savings can be achieved.

1. A method for the heating of natural gas, comprising:
a) delivering natural gas having a temperature in the range of −10° C. to 50° C. and under a pressure of at least 30 bar from a natural gas supply line to a first cavity system of a heat exchanger,
b) delivering a heating medium having a temperature in the range of 30° C. to 160° C. to a second cavity system of the heat exchanger, the first and the second cavity system being sealed off with respect to one another and with respect to the surroundings,
c) heating the natural gas in the first cavity system to a temperature in the range of 20° C. to 150° C. by the heating medium in the second cavity system,
the heat exchanger being a plate heat exchanger comprising at least two pairs of heat exchanger plates, and the heat exchanger plates of each pair of heat exchanger plates being welded together completely at least at their outer margins, and
d) discharging the heated natural gas from the first cavity system to at least one further treatment stage.

2. The method according to claim 1, wherein a) the natural gas is delivered to the plate heat exchanger under a pressure of up to 150 bar.

3. The method according to claim 1, wherein the natural gas is process natural gas.

4. The method according to claim 1, wherein the at least one further treatment stage comprises further heating and/or pressure reduction and/or chemical reaction and/or combustion.

5. A plant, comprising:
a heat exchanger having a first cavity system for natural gas and a second cavity system for a heating medium, the first and the second cavity system being sealed off with respect to one another and with respect to the surroundings,
a delivery for natural gas from a natural gas supply line to the first cavity system of the heat exchanger, and
a discharge for the heated natural gas from the first cavity system to at least one further treatment stage,
wherein
the heat exchanger is a plate heat exchanger comprising at least two pairs of heat exchanger plates, and the heat exchanger plates of each pair of heat exchanger plates being welded together completely at least at their outer margins.

6. The plant according to claim 5, wherein the plate heat exchanger can be acted upon with a pressure of up to 150 bar.

7. The plant according to claim 5, wherein the at least one further treatment stage has a further heat exchanger or an expansion device for the pressurized natural gas.

8-9. (canceled)
